(19) United States
(12) Patent Application Publication
(10) Pub. No.: US 2017/0047156 A1
(43) Pub. Date: Feb. 16, 2017

(54) REACTOR

(71) Applicant: DENSO CORPORATION, Kariya-city, Aichi-pref. (JP)

(72) Inventors: Akira SAKAMOTO, Kariya-city (JP); Kazuhiro UMETANI, Kariya-city (JP); Naoya KONDOU, Kariya-city (JP)

(21) Appl. No.: 15/307,071

(22) PCT Filed: May 21, 2015
(86) PCT No.: PCT/JP2015/002565

§ 371 Date: Oct. 27, 2016

(30) Foreign Application Priority Data
Jun. 3, 2014 (JP) 2014-114861

(51) Int. Cl. H01F 27/255; H01F 27/16; H01F 27/28

(52) U.S. Cl. CPC H01F 27/255; H01F 27/2823; H01F 27/16

(57) ABSTRACT

A reactor includes a magnetic core and a plurality of coils disposed adjacent to each other and electrically connected to each other. The plurality of coils includes an intermediate coil inducing a magnetic flux which does not interlink with an end of the magnetic core, and magnetic paths forming at least two closed magnetic paths run through a portion inside the intermediate coil.

### CROSS REFERENCE TO RELATED APPLICATION

The present application is based on Japanese Patent Application No. 2014-114861 filed on Jun. 3, 2014, the disclosure of which is incorporated herein by reference.

### TECHNICAL FIELD

The present disclosure relates to a reactor including a magnetic core and coils.

### BACKGROUND ART

A hybrid car or an electric car or the like is equipped with a drive device called a power control unit having a large-capacity inverter device to drive an electric motor under control. The power control unit is provided with a boost converter boosting a DC voltage (for example, 201.6 V) across a battery to a high voltage (for example, up to 650 V). The boosted DC high voltage is supplied to the inverter device. The boost converter includes a reactor and two switching elements (IGBTs or MOSFETs).

The reactor of a type described above is disclosed in Patent Literature 1. More specifically, as is shown in FIG. 11, a reactor main body 1 includes a magnetic core 2 and coils 3 wound around the magnetic core 2 and is enclosed in a frame-shaped case 4 made of metal, such as aluminum. The magnetic core 2 includes two inner core portions and a yoke portion connecting the two inner core portions and is formed in a rectangular shape. The coils 3 are wound around the respective inner core portions and the coils 3 are connected in series. A radiator plate 5 made of aluminum is provided to a bottom surface of the case 4. The reactor main body 1 is bonded to an upper surface of the radiator plate 5 via a bonding layer 6 made of resin. The bonding layer 6 is made of heat-dissipating resin containing filler to increase heat conductivity while ensuring insulation between the reactor main body 1 and the radiator plate 5.

According to the configuration in the prior art as above, cooling performance for the reactor main body 1 can be ensured in a portion near the radiator plate 5. However, radiation performance deteriorates in a portion away from the radiator plate 5 or the case 4, that is, a portion on an upper surface side of the reactor main body 1 and an inner portion of the magnetic core 2. Such deterioration of radiation performance is attributed to heat conductivity. That is, the coils 3 are made of copper or aluminum having relatively high heat conductivity (about 200 W/mK or higher) whereas the magnetic core 2 is made of iron-based alloy, amorphous, ferrite, or the like having poor heat conductivity (about 1 to 50 W/mK). The magnetic core 2 has a relatively large dimension H (several cm or more) in a height (thickness) direction and therefore is distant from the radiator plate 5. Hence, radiation performance of the magnetic core 2 becomes poor. Accordingly, the magnetic core 2 may possibly become abnormally hot due to heat generated by, for example, an iron loss in the magnetic core 2. For example, the magnetic core 2 may become hotter than a heat resistance temperature of the magnetic core 2 and may break in the end.

### PRIOR ART LITERATURES

### Patent Literature

[Patent Literature 1] JP 2013-30721 A

### SUMMARY OF INVENTION

An object of the present disclosure is to provide a reactor including a magnetic core and coils and having satisfactory radiation performance while being relatively small.

A reactor according to an aspect of the present disclosure includes a magnetic core and a plurality of coils disposed adjacent to each other and electrically connected to each other. The plurality of coils includes an intermediate coil inducing a magnetic flux which does not interlink with an end of the magnetic core, and magnetic paths forming at least two closed magnetic paths run through a portion inside the intermediate coil.

According to the reactor configured as above, the magnetic core can be thinner. Consequently, because a thickness of the magnetic core can be reduced for a radiation surface, radiation performance from the magnetic core and hence overall radiation performance can be enhanced.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view schematically showing a configuration of a reactor according to a first embodiment of the present disclosure;

FIG. 2 is a partial perspective view of a coil;

FIG. 3 is a perspective view schematically showing a configuration of a reactor according to a second embodiment of the present disclosure;

FIG. 4 is a perspective view schematically showing a configuration of a reactor according to a third embodiment of the present disclosure;

FIG. 5 is a perspective view schematically showing a connection state of respective coils in a reactor according to a fourth embodiment of the present disclosure;

FIG. 6 is a schematic perspective view of a reactor main body according to a fifth embodiment of the present disclosure;

FIG. 7 is a view used to describe a manufacturing method of the reactor main body;

FIG. 8 is a schematic front view of a reactor main body according to a sixth embodiment of the present disclosure;

FIG. 9 is a schematic perspective view of a reactor main body according to a seventh embodiment of the present disclosure;

FIG. 10 is a schematic front view of a reactor main body according to an eighth embodiment of the present disclosure;

FIG. 11 is an exploded perspective view of a reactor in the prior art; and

FIG. 12 is a perspective view schematically showing a configuration of a reactor of a reference example.

### DESCRIPTION OF EMBODIMENTS

### First Embodiment

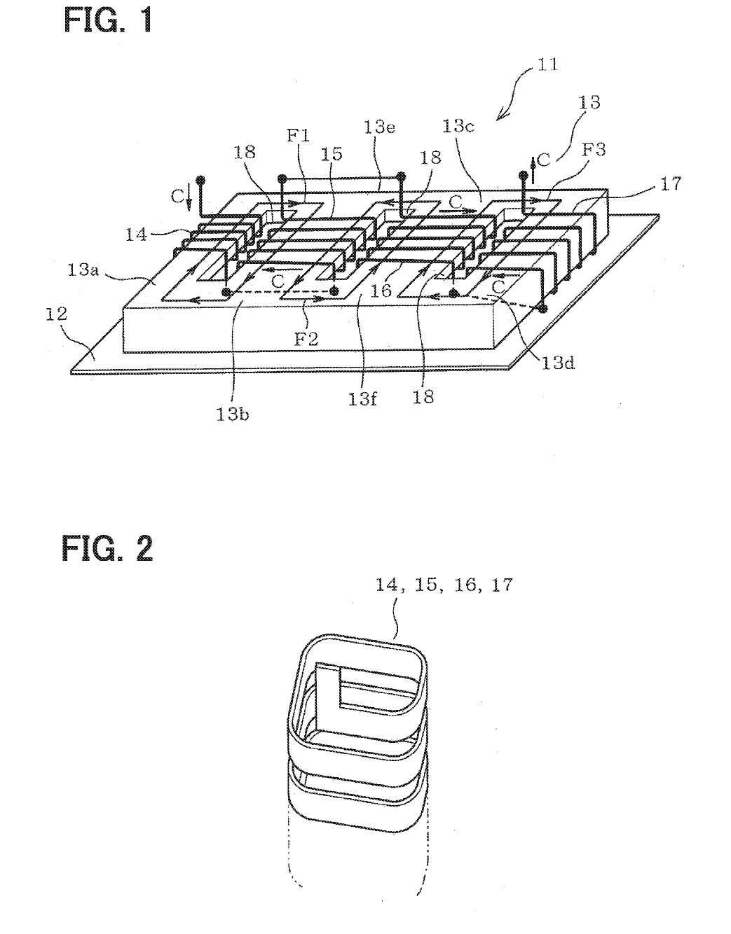

Hereinafter, a first embodiment in a practical form of the present disclosure will be described with reference to FIG. 1, FIG. 2, and FIG. 12. In respective embodiments described below, the present disclosure is applied to a reactor used in a non-isolated boost converter, such as a power control unit in a hybrid car or the like. In a description of the present embodiment, directions are defined as follows. That is, an alignment direction of coils is a lateral (right-left) direction, a longer direction of the coils (a direction in which winding spaces extend) is a front-back direction, and a thickness direction of a magnetic core (a penetrating direction of the winding spaces) is a top-bottom direction. Also, the lateral direction corresponds to a first direction and a longitudinal direction corresponds to a second direction.

FIG. 1 schematically shows a configuration of a reactor main body 11 of the present embodiment. A reactor includes the reactor main body 11 enclosed in a case (only a bottom plate portion is shown). The bottom plate portion of the case is a radiator plate 12 shaped like a rectangular thin plate and made of metal, for example, aluminum. The reactor main body 11 includes a magnetic core 13 made of, for example, iron-based alloy or amorphous, and multiple coils, herein, four coils 14-17. When the four coils are distinguished from one another, the coils from left to right in the drawing are referred to as a first coil 14, a second coil 15, a third coil 16, and a fourth coil 17.

The magnetic core 13 is shaped like a rectangular plate made thin in the top-bottom (thickness) direction, that is, a slightly horizontally-long rectangular plate flat in a planar direction (front-back and right-left directions) of the radiation plate 12, and has three winding spaces 18. The winding spaces 18 are provided to extend in the front-back direction and penetrate through the magnetic core 13 in the top-bottom (thickness) direction. Thus, the magnetic core 13 has a form including four leg portions 13a-13d extending in the front-back direction and wrapped by the coils 14-17, respectively, and integrally having yoke portions 13e and 131 connecting the leg portions 13a-13d at back and front side portions, respectively.

The end leg portions 13a and 13d are located, respectively, at left and right ends of the magnetic core 13 in the drawing and the intermediate leg portions 13b and 13c are located between the end leg portions 13a and 13d. In the present embodiment, a cross-sectional area of the end leg portions 13a and 13d (first coil 14 and the fourth coil 17) is smaller than a cross-sectional area of the remaining intermediate leg portions 13b and 13c (second coil 15 and the third coil 16). In FIG. 1, a cross-sectional area of the end leg portions 13a and 13d is half of a cross-sectional area of the intermediate leg portions 13b and 13c. Although it is not shown in detail in the drawing, the magnetic core 13 may be formed by, for example, winding the coils 14-17 around a die-molded magnetic core or connecting comb-teeth (so-called E-shape) parts and linear (I-shape) parts after the coils 14-17 are attached to the corresponding parts.

The first through fourth coils 14-17 are wound, respectively, around the four leg portions 13a trough 13d of the magnetic core 13. Each of the coils 14-17 is wound from a far left (back portion) on an upper surface of the magnetic core 13 toward a front side in the drawing. Herein, the number of turns is same in all of the coils 14-17. The four coils 14-17 are disposed side by side (adjacent to one another) in the lateral direction, which is a radial direction of the coils 14-17. In the present embodiment, as is shown in FIG. 2, flatwise coils are suitably adopted as the respective coils 14-17. It should be understood that the coils 14-17 are disposed in such a manner that the longer directions of any two coils among the coils 14-17 disposed adjacent to each other do not intersect at a right angle.

In addition, as is shown in FIG. 1, a winding end edge (front end in the drawing) of the first coil 14 is connected to a winding end edge of the second coil 15, a winding start edge (back end in the drawing) of the second coil 15 is connected to a winding start edge of the third coil 16, and a winding end edge (front end in the drawing) of the third coil 16 is connected to a winding end edge of the fourth coil 17. Consequently, the four coils 14-17 are disposed adjacent to one another and also electrically connected to one another in series and a pair of terminals are extracted from a winding start edge of the first coil 14 and a winding start edge of the fourth coil 17.

When a DC current is passed through the coils 14-17 (between a pair of the terminals), a current flows through the respective coils 14-17 in directions indicated by arrows C of FIG. 1. In the coils 14-17 disposed adjacent to one another, the current flows in a same direction in respective adjacent portions. More specifically, a right side surface of the first coil 14 and a left side surface of the second coil 15 are disposed adjacent to each other in the winding space 18 on the left, and the current flows from top to bottom in both of the first coil 14 and the second coil 15 in the adjacent portion.

A right side surface of the second coil 15 and a left side surface of the third coil 16 are disposed adjacent to each other in the winding space 18 at a center, and the current flows from bottom to top in both of the second coil 15 and the third coil 16 in the adjacent portion. Further, a right side surface of the third coil 16 and a left side surface of the fourth coil 17 are disposed adjacent to each other in the winding space 18 on the right, and the current flows from top to bottom in both of the third coil 16 and the fourth coil 17 in the adjacent portion.

Owing to the current passing through the coils 14-17 in the manner as above, magnetic fluxes are induced in the magnetic core 13 and, as is shown in FIG. 1, three closed magnetic paths F1, F2, and F3 are formed in the magnetic core 13. In such a case, two magnetic paths forming two closed magnetic paths run through a portion inside each of the second coil 15 and the third coil 16 disposed in a center portion. That is to say, two magnetic paths forming the closed magnetic paths F1 and F2 run through the intermediate leg portion 13b inside the second coil 15 and two magnetic paths forming the closed magnetic paths F2 and F3 run through the intermediate leg portion 13c inside the third coil 16.

Further, a magnetic path forming one closed magnetic path runs through a portion inside each of the first coil 14 and the fourth coil 17 provided for an induced magnetic flux to interlink with an end of the magnetic core 13. In other words, one magnetic path forming the closed magnetic path F1 runs through the end leg portion 13a as a portion inside the first coil 14 and one magnetic path forming the closed magnetic path F3 runs through the end leg portion 13d as a portion inside the fourth coil 17. In the present embodiment, the second coil 15 and the third coil 16 correspond to an intermediate coil inducing a magnetic flux which does not interlink with the end of the magnetic core 13 and the first coil 14 and the seventeenth coil correspond to an end coil inducing a magnetic flux which interlinks with the end of the magnetic core 13.

The reactor main body 11 configured as above is enclosed in the case. More specifically, the reactor main body 11 is flattened out in a planar direction (front-back and right-left directions) of the radiator plate 12, that is, flattened out in a horizontal direction in the drawing and fixed firmly to an upper surface of the radiator plate 12 via insulating resin (not shown) containing filler to increase heat conductivity. In such a case, an insulating resin layer is a layer as thin as or thinner than several mm. The radiator plate 12 is provided to a surface on one side in FIG. 1. It should be appreciated, however, that the radiator plate may be provided to the reactor main body 11 on both surfaces on upper and lower sides in the drawing. The radiator plate 12 may be cooled by either air or water.

In the reactor of the present embodiment configured as above, heat generated due to a loss occurring when the reactor main body 11 is driven is dissipated through the radiator plate 12. Because the reactor main body 11 is flattened out in the planar direction of the radiator plate 12, that is, flattened out in the horizontal direction in the drawing and therefore made thin entirely in the thickness direction, the radiator plate 12 (cooling surface) can be larger and the reactor main body 11 is allowed to make contact with the cooling surface in a larger area. Hence, radiation performance can be satisfactory. At the same time, because a distance from an inner portion (magnetic core 13) of the reactor main body 11 to the radiator plate 12 is short, heat in the inner portion can be readily dissipated from the radiator plate 12. In the present embodiment, in particular, by adopting flatwise coils as the coils 14-17, a winding thickness of the coils 14-17 is reduced. Hence, a distance from the magnetic core 13 to the radiator plate 12 can be shortened further. Consequently, radiation performance can be better.

In order to form a magnetic circuit equivalent to the reactor main body 11 of the present embodiment in a reactor including coils wound around a rectangular magnetic core as described in the prior art above while making the magnetic core thinner, an outcome may be a reactor main body 101 configured according to a reference example as shown in FIG. 12. The reactor main body 101 includes three unit reactors 104, each of which is formed by winding serially-connected coils 103 and 103 around a thin magnetic core 102, and which are aligned side by side on a radiator plate 105 and connected in series.

In the reactor main body 101 of the reference example, however, an overall coil length of a total of six coils 103 in a height direction becomes longer than a coil length of the present embodiment (an overall length of the four coils 14-17) and a copper loss is increased accordingly. It is also apparent that the reactor main body 101 becomes larger in size than the reactor main body 11 of the present embodiment. In contrast, in the reactor main body 11 of the present embodiment, the magnetic core 13 can be thinner while ensuring inductance (necessary inductance) as much as inductance in the reactor main body 101 of the reference example. Hence, not only can heat generation be restricted, but also an overall size can be reduced.

In the present embodiment, the first coil 14 and the fourth coil 17 can be formed as identical coils and the second coil 15 and the third coil 16 can be also formed as identical coils. Hence, the reactor main body 11 can be manufactured simply by attaching the coils 14-17 prepared in advance to corresponding magnetic cores and bonding the magnetic cores together and also bonding the coils together and electrically connecting the coils. Hence, the present embodiment has an advantage that it is quite easy to manufacture the reactor main body 11. In FIG. 1, the number of turns is same in the respective coils 14-17. However, the number of turns may be different.

In addition, in the present embodiment, the reactor is made thinner and therefore a center of gravity is low. Accordingly, the reactor of the present embodiment is robust against vibrations when equipped to a vehicle. Further, although it is not shown in the drawings, the reactor may be combined with another electronic component (for example, smoothing capacitor) and cooled at a time by the single radiator plate 12 or the reactor may be cooled by adopting a double-sided cooling configuration in which the radiator plate is also provided to an upper surface of the reactor.

### Second Embodiment

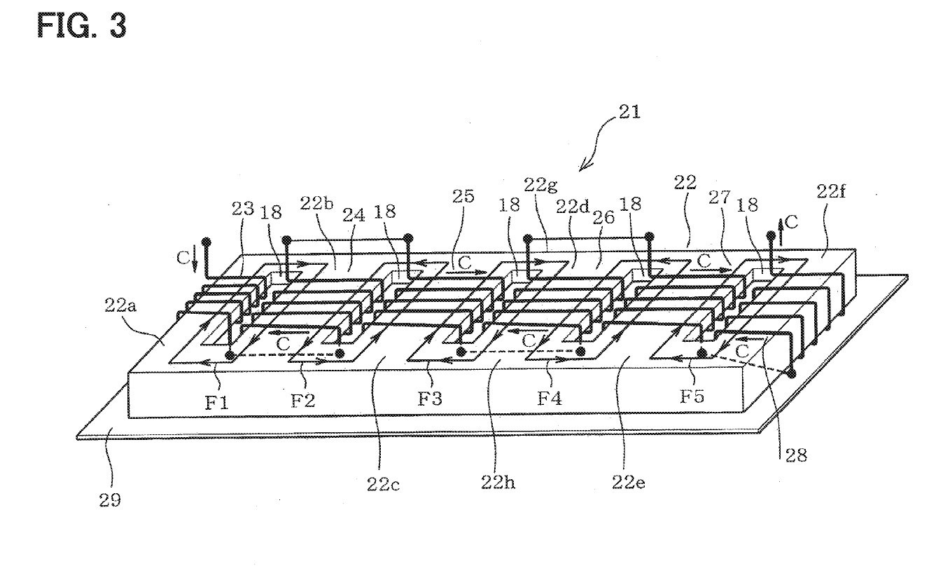

FIG. 3 shows a schematic configuration of a reactor according to a second embodiment of the present disclosure. In the respective embodiments described below, portions same as portions in the first embodiment above (or preceding embodiment(s)) are labeled with same reference numerals to omit a detailed description, and a difference from the preceding embodiment(s) will be chiefly described.

A reactor main body 21 of the second embodiment includes multiple coils in one magnetic core 22. The multiple coils are, from left to right in the drawing, a first coil 23, a second coil 24, a third coil 25, a fourth coil 26, a fifth coil 27, and a sixth 28. The magnetic core 22 is shaped like a horizontally-long rectangular plate made thin in a top-bottom (thickness) direction, that is, flattened out in a planar direction (front-back and right-left directions) of a radiator plate 29 disposed in a bottom portion. Also, the magnetic core 22 has five winding spaces 18 aligned side by side in a lateral direction. Each winding space 18 extends in a front-back direction and penetrates through the magnetic core 22 in the thickness direction. Thus, the magnetic core 22 has a form including six leg portions 22a-22f extending in the front-back direction and wrapped by the coils 23-28, respectively, and integrally having yoke portions 22g and 22h connecting the leg portions 22a-22f at rear and front side portions, respectively.

In the configuration as above, too, as in the first embodiment above, a cross-sectional area of the end leg portions 22a and 22f located, respectively, at left and right ends of the magnetic core 22 in the drawing is smaller than (in FIG. 3, half of) a cross-sectional area of respective intermediate leg portions 13b-13e. The coils 23-28 are formed of flatwise coils and wound by a same number of turns, respectively, around the leg portions 22a-22f from a far left (back portion) on an upper surface toward a front side. The six coils 23-28 are disposed adjacent to one another and electrically connected to one another in series. A pair of terminals are extracted from a winding start edge of the first coil 23 and a winding start edge of the sixth coil 28.

When a DC current is passed between a pair of the terminals, a current flows through the respective coils 23-28 in directions indicated by arrows C of FIG. 3. In the coils 23-28 disposed adjacent to one another, the current flows in a same direction in respective adjacent portions. Accordingly, five closed magnetic paths F1-F5 are formed in the magnetic core 22. In each of the second coil 24, the third coil 25, the fourth coil 26, and the fifth coil 27 disposed in a center portion, two magnetic paths forming two closed magnetic paths run through a portion inside the corresponding coil (each of the intermediate leg portions 13b-13e). The reactor main body 21 configured as above is firmly fixed to an upper surface of the radiator plate 29 via insulating resin (not shown) containing filler to increase heat conductivity. In the present embodiment, the second coil 24, the third coil 25, the fourth coil 26, and the fifth coil 27 correspond to an intermediate coil and the first coil 23 and the sixth coil 28 correspond to an end coil.

As in the first embodiment above, the reactor of the second embodiment including the magnetic core 22 and the coils 23-28 is also capable of obtaining excellent function and effect that radiation performance can be satisfactory while being a relatively small (thin). In comparison with the reactor of the first embodiment above, the number of turns can be increased by increasing the number of coils 23-28 while making an overall shape larger in the planar direction. Consequently, inductance can be increased while ensuring as good cooling performance as in the first embodiment above.

### Third Embodiment

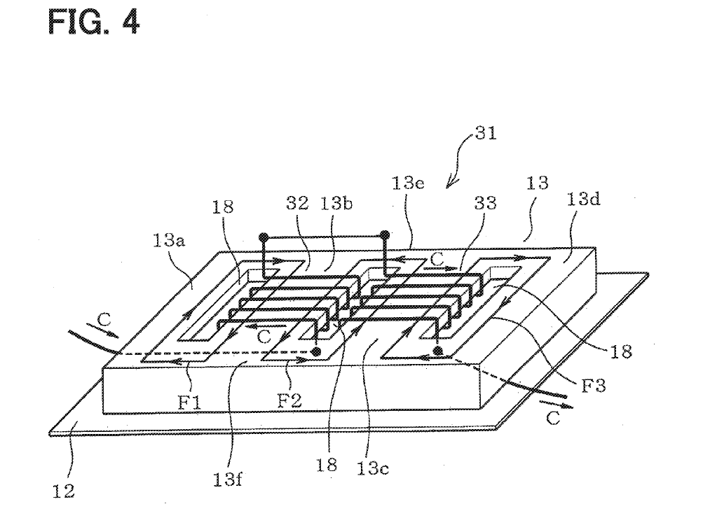

FIG. 4 shows a configuration of a reactor main body 31 according to a third embodiment of the present disclosure. The reactor main body 31 is different from the reactor main body 11 of the first embodiment above having a magnetic core 13 in that coils are not wound around end leg portions 13a and 13d. That is to say, the reactor main body 31 includes a magnetic core 13 same as the magnetic core 13 of the first embodiment above and a first coil 32 is wound around an intermediate leg portion 13b and a second coil 33 is wound around another intermediate leg portion 13c. In other words, each of the coils 32 and 33 of the present embodiment is an intermediate coil inducing a magnetic flux which does not interlink with an end of the magnetic core 13.

The respective coils 32 and 33 are formed of flatwise coils and wound by a same number of turns from a far left (back portion) on an upper surface of the magnetic core 13 toward a front side in the drawing. The two coils 32 and 33 are disposed side by side (next to each other) in a lateral direction (first direction), which is a radial direction of the coils 32 and 33. A winding start edge (back end in the drawing) of the first coil 32 and a winding start edge of the second coil 33 are connected in series and a pair of terminals are extracted from a winding end edge (front end in the drawing) of the first coil 32 and a winding end edge of the second coil 33.

When a DC current is passed through the coils 32 and 33 (passed between a pair of the terminals), a current flows through the respective coils 32 and 33 in directions indicated by arrows C. Accordingly, magnetic fluxes are induced in the magnetic core 13 and three closed magnetic paths F1, F2, and F3 are formed in the magnetic core 13. In the present embodiment, too, the reactor main body 31 is flattened out in a planar direction of a radiator plate 12, that is, flattened out in a horizontal direction in the drawing and firmly fixed to an upper surface of the radiator plate 12 via insulating resin (not shown) containing filler to increase heat conductivity.

As with the first embodiment above, a reactor of the third embodiment including the magnetic core 13 and the coils 32 and 33 as above is also capable of obtaining excellent function and effect that radiation performance can be satisfactory while being relatively small (thin). In addition, because coils are not wound around the ends (end leg portions 13a and 13d) of the magnetic core 13, induced magnetic fields remain in the vicinity of the magnetic core. Hence, an adverse influence given to an outside by magnetic fluxes leaking from the coils can be prevented effectively.

### Fourth Embodiment

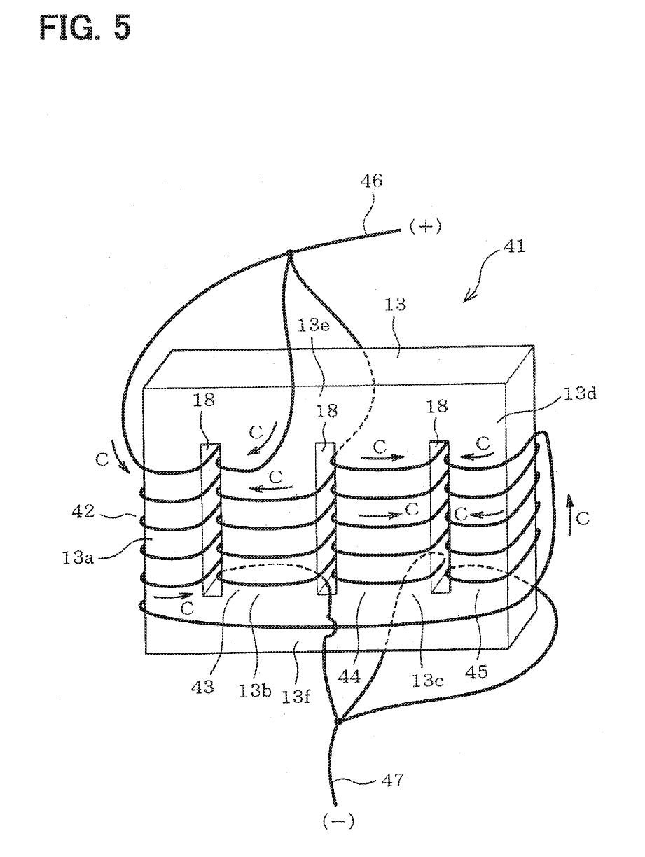

FIG. 5 shows a configuration of a reactor main body 41 according to a fourth embodiment of the present disclosure. FIG. 5 shows the reactor main body 41 standing upright (an axial direction of coils is given as a top-bottom direction). The reactor main body 41 of the fourth embodiment is formed by attaching four coils, namely, a first coil 42, a second coil 43, a third coil 44, and a fourth coil 45, to a magnetic core 13. It should be noted that the four coils 42-45 are connected in a manner different from the manner in the first embodiment above. That is to say, the first coil 42 is wound around an end leg portion 13a of the magnetic core 13 downward from an upper left on a front surface in the drawing, and contrary to the first coil 42, the second coil 43 is wound around an intermediate leg portion 13b downward in an opposite winding direction from an upper right on the front surface in the drawing.

The third coil 44 is wound around an intermediate leg portion 13c downward from an upper left on the front surface in the drawing whereas the fourth coil 45 is wound around an end leg portion 13d of the magnetic core 13 downward in an opposite winding direction from an upper right on the front surface in the drawing. Further, a winding end edge of the first coil 42 is connected to a winding start edge of the fourth coil 45 in series. One (+) terminal 46 located on an upper side in the drawing is connected to a winding start edge of the first coil 42, a winding start edge of the second coil 43, and a winding start edge of the third coil 44 and the other (−) terminal 47 is connected to a winding end edge of the second coil 43, a winding end edge of the third coil 44, and a winding end edge of the fourth coil 45.

Consequently, three components, that is, the first coil 42 and the fourth coil 45 connected in series, the second coil 43, and the third coil 44 are connected in parallel between the two terminals 46 and 47. In the case as above, too, when a DC current is passed between a pair of the terminals 46 and 47, a current flows through the respective coils 42-45 in directions indicated by arrows C. Accordingly, magnetic fluxes are induced in the magnetic core 13 and three closed magnetic paths are formed in the magnetic core 13. In the present embodiment, too, the reactor main body 41 is cooled via an unillustrated radiator plate.

As in the first embodiment and the like above, a reactor of the fourth embodiment configured as above is also capable of obtaining excellent function and effect that radiation performance can be satisfactory while being relatively small (thin in a front-back direction in the drawing). In comparison with a case where all coils are connected in series, the reactor of the present embodiment is a low-inductance and high-current reactor. Hence, the connection method described in the present embodiment is effective when a high-current reactor is designed.

In the magnetic core 13 of the present embodiment, one magnetic path is formed in each of the end leg portions 13a and 13d and two magnetic paths are formed in each of the intermediate leg portions 13b and 13c. Hence, flux density passing through all of the leg portions 13a-13d can be made homogeneous by connecting the first coil 42 and the fourth coil 45 in series and the second coil 43 and the third coil 44 in parallel. Accordingly, a problem of magnetic saturation occurring with a small amount of current in a particular one of the leg portions 13a-13d can be eliminated. Hence, a DC superimposing characteristic can be enhanced further.

### Fifth Embodiment

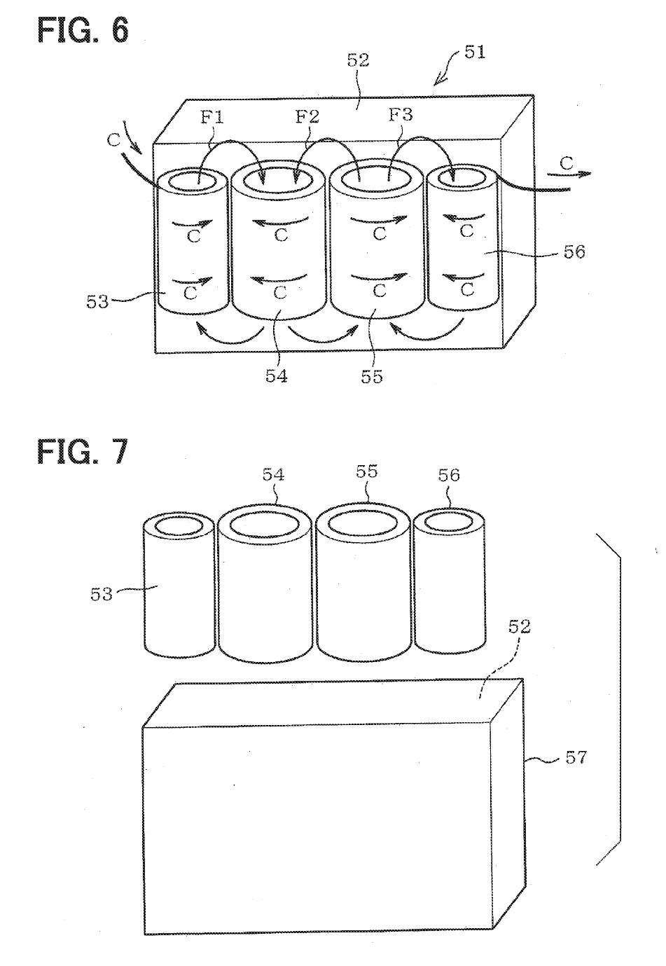

A fifth embodiment of the present disclosure will now be described with reference to FIG. 6 and FIG. 7. In the present embodiment and embodiments below, a description will be given by defining an axial direction (longer direction) of coils as a top-bottom direction. A reactor main body 51 of the fifth embodiment includes a magnetic core 52 shaped like a rectangular block as a whole and multiple coils, for example, a first coil 53, a second coil 54, a third coil 55, and a fourth coil 56 embedded in the magnetic core 52. The reactor main body 51 is enclosed in a case (not shown) with satisfactory heat conductivity (radiation performance). The magnetic core 52 used herein is fluid made of, for example, magnetic powder (powder of iron alloy, amorphous, or the like) compacted by mixing the magnetic powder with heat-dissipating resin containing filler to increase heat conductivity or by dispersing the magnetic powder in the resin. The magnetic core 52 is hardened with heating after the coils 53-56 are placed in the magnetic core 52.

Each of the coils 53-56 is formed by molding a wire coiled up in a hollow circular cylindrical shape with insulating resin. Herein, the number of turns is same in the four coils 53-56. However, as is shown in FIG. 6, a diameter dimension of the second coil 54 and the third coil 55 is made larger than a diameter dimension of the first coil 53 and the fourth coil 56. The four coils 53-56 are disposed side by side in a lateral direction by defining an axial direction (longer direction) as a top-bottom direction in the drawing. As in the first embodiment above, the four coils 53-56 are electrically connected in series.

As is shown in FIG. 7, the reactor main body 51 is manufactured by placing fluid mixed powder as a material from which to make the magnetic core 52 into a molding die 57 of a rectangular box shape and embedding the four connected and electrically-isolated coils 53-56 into the mixed powder. The magnetic core 52 is formed by allowing the mixed powder to harden with heating. Consequently, the magnetic core 52 is provided so as to cover each of the four coils 53-56 along an entire circumference.

In the reactor main body 51 configured as above, when a DC current is passed between a pair of terminals, a current flows through the respective coils 53-56 in directions indicted by arrows C of FIG. 6 and the current flows in a same direction (from back to front or from front to back) in respective adjacent portions of the coils 53-56 disposed adjacent to one another. Three closed magnetic paths F1, F2, and F3 are formed in the magnetic core 52. Two magnetic paths forming the closed magnetic paths Fl and F2 run through an inner peripheral portion of the second coil 54 and two magnetic paths forming the closed magnetic paths F2 and F3 run through an inner peripheral portion of the third coil 55.

In a reactor of the fifth embodiment configured as above, too, the entire reactor main body 51 (magnetic core 52) is made thin in a front-back direction in the drawing. Hence, the reactor of the fifth embodiment is also capable of obtaining excellent function and effect, for example, that radiation performance from a front surface or a rear surface of the case can be satisfactory while being relatively small (thin).

### Sixth Embodiment

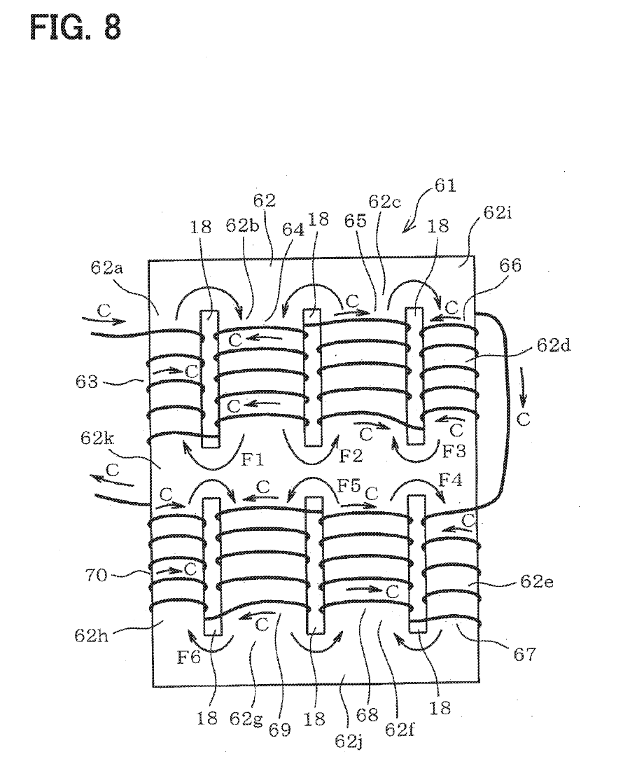

FIG. 8 schematically shows a configuration of a reactor main body 61 according to a sixth embodiment of the present disclosure. The reactor main body 61 includes a magnetic core 62 provided with a first coil 63, a second coil 64, a third coil 65, a fourth coil 66, a fifth coil 67, a sixth coil 68, a seventh coil 69, and an eighth coil 70. The coils 63-70 are disposed in two rows in a longitudinal direction (top-bottom direction in the drawing), which is a longer direction of the coils 63-70, and four coils are aligned side by side in a lateral direction in each row. In other words, a reactor including four coils aligned side by side in the lateral direction as in the first embodiment above is provided in each of two rows in the top-bottom direction. That is to say, in the present embodiment, four sets of two coils lined up in the longitudinal direction (second direction) are disposed side by side in the lateral direction (first direction).

The magnetic core 62 is provided with a total of six winding spaces 18, that is, three winding paces 18 aligned side by side in the lateral direction are provided in each of two rows in the longitudinal direction. Accordingly, the magnetic core 62 integrally includes upper-row end leg portions 62a and 62d, upper-row intermediate leg portions 62b an 62c, lower-row end leg portions 62e and 62h, lower-row intermediate leg portions 62f and 62g, an upper yoke portion 62i, a lower yoke portion 62j, and an intermediate yoke portion 62k. The intermediate yoke portion 62k is used in common by the upper-row side and the lower-row side. A cross-sectional area of the end leg portions 62a, 62d, 62e, and 62h is smaller than a cross-sectional area of the intermediate leg portions 62b, 62c, 62f, and 62g, and the former is half of the latter in FIG. 8.

The coils 63-70 are wound around the leg portions 62a-62h, respectively, by a same number of turns in a same direction, that is, downward from an upper left on a front surface. A winding end edge (lower end) of the first coil 63 is connected to a winding end edge of the second coil 64, a winding start edge (upper end) of the second coil 64 is connected to a winding start edge of the third coil 65, and a winding end edge of the third coil 65 is connected to a winding end edge of the fourth coil 66. Further, a winding start edge of the fourth coil 66 is connected to a winding start edge of the fifth coil 67, a winding end edge of the fifth coil 67 is connected to a winding end edge of the sixth coil 68, a winding start edge of the sixth coil 68 is connected to a winding start edge of the seventh coil 69, and a winding end edge of the seventh coil 69 is connected to a winding end edge of the eighth coil 70. A winding start edge of the first coil 63 and a winding start edge of the eighth coil 70 are respectively connected to terminals.

Consequently, the eight coils 63-70 are electrically connected in series, and when a DC current is passed between a pair of the terminals, a current flows through the respective coils 63-70 in directions indicated by arrows C of FIG. 8. The current flows in a same direction (from front to back or from back to front) in respective adjacent portions of the coils 63-70 disposed adjacent to one another. Six closed magnetic paths F1-F6 are formed in the magnetic core 62. Two magnetic paths forming two closed magnetic paths F1 and F2, F2 and F3, F4 and F5, and F5 and F6 run through the intermediate leg portions 62b, 62c, 62f, and 62g, respectively. One magnetic path runs through each of the end leg portions 62a, 62d, 62e, and 62h.

The upper and lower coils 63-70 lined up in the second direction are formed to induce magnetic fluxes in a same direction. Hence, in the intermediate yoke portion 62k, magnetic fields generated by the coils 63-70 in the upper and lower rows are in opposite directions and therefore cancel out one another. That is to say, in the intermediate yoke portion 62k, magnetic fluxes in the closed magnetic path F1 and the closed magnetic path F6 are in opposite directions. Likewise, magnetic fluxes in the closed magnetic path F2 and the closed magnetic path F5 are in opposite directions, and magnetic fluxes in the closed magnetic path F3 and the closed magnetic path F4 are in opposite directions.

According to the reactor main body 61 of the sixth embodiment configured as above, the multiple coils 63-70 can be disposed effectively while increasing inductance not only by disposing the coils 63-70 side by side in the lateral direction, but also by lining up the coils 63-70 in the longitudinal direction. The configuration as above can prevent the reactor main body 61 as a whole from becoming longer (larger in size) in one direction. Although it is not shown in the drawing, a cooling effect can be increased by providing a radiator plate to the reactor main body 61 on front and rear surfaces. In the present embodiment, in particular, magnetic fields in the intermediate yoke portion 62k are in directions such that the magnetic fields cancel out one another. Hence, magnetic saturation in this point can be restricted and a cross-sectional area of the intermediate yoke portion 62k can be smaller.

### Seventh Embodiment

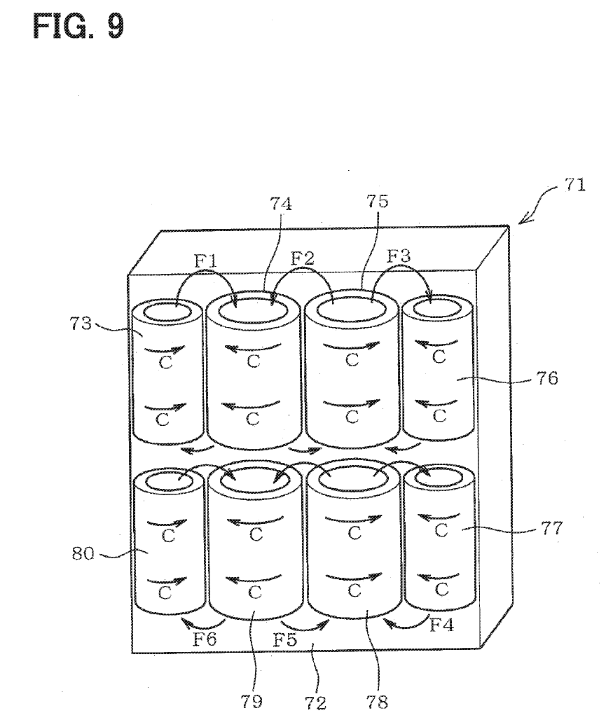

FIG. 9 schematically shows a configuration of a reactor main body 71 according to a seventh embodiment of the present disclosure. The reactor main body 71 includes a magnetic core 72 and a first coil 73, a second coil 74, a third coil 75, a fourth coil 76, a fifth coil 77, a sixth coil 78, a seventh coil 79, and an eighth coil 80 which are aligned side by side in two rows in a top-bottom direction and four columns in a lateral direction and embedded in the magnetic core 72. The magnetic core 72 as a whole is shaped like a rectangular block thin in a front-back direction. As with the magnetic core 52 (see FIGS. 6 and 7) of the fifth embodiment above, the magnetic core 72 is obtained by placing fluid mixed powder prepared by mixing magnetic powder with insulating resin into a molding die (case), placing the coils 73-80 inside the case, and allowing the mixed power to harden.

As in the fifth embodiment above, the coils 73-80 are obtained by molding a wire coiled up into a circular cylindrical shape with insulating resin. The coils 73-80 are connected (in series) in the same manner as in the sixth embodiment above, and four coils aligned side by side in four directions in each of two rows in a top-bottom direction are embedded in the magnetic core 52. A diameter dimension of the second coil 74, the third coil 75, the sixth coil 78, and the seventh coil 79 is made larger than a diameter dimension of the first coil 73, the fourth coil 76, the fifth coil 77, and the eighth coil 80. In the reactor main body 71 configured as above, when a DC current is passed between a pair of terminals, a current flows in the respective coils 73-80 in directions indicated by arrows C and six closed magnetic paths F1-F6 are formed in the magnetic core 72.

Hence, as in the sixth embodiment above, a reactor of the seventh embodiment is also capable of obtaining satisfactory radiation performance from a front surface or a rear surface while being relatively small (thin) in a front-back direction. In addition, magnetic saturation in the magnetic core 72 in a portion corresponding to an intermediate yoke can be restricted.

### Eighth Embodiment

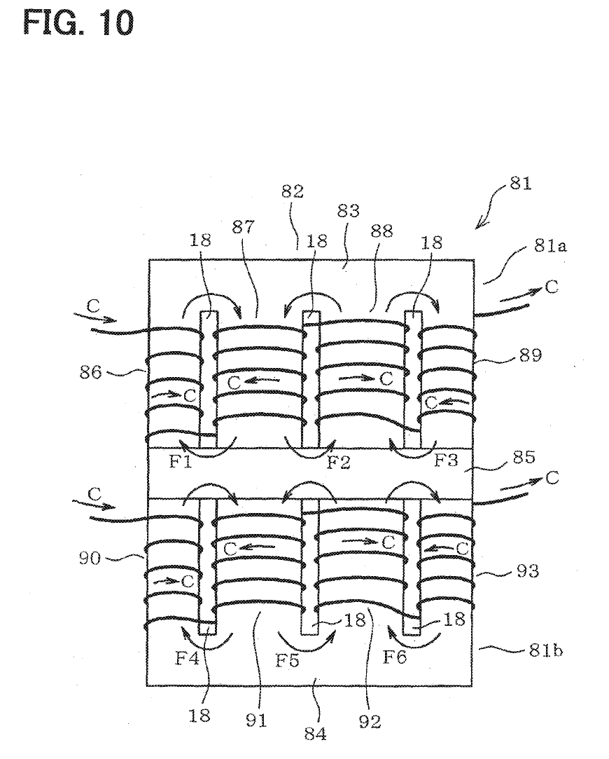

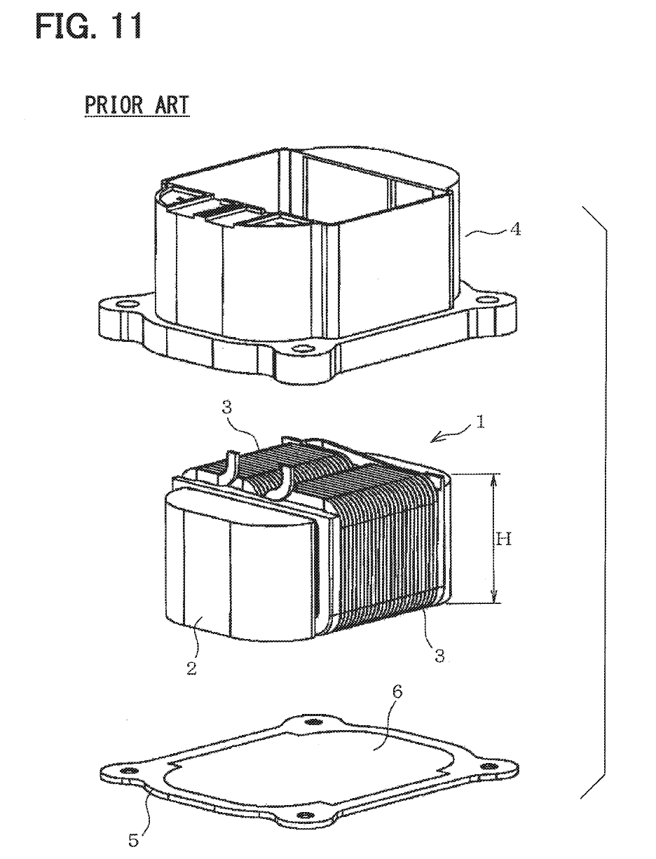

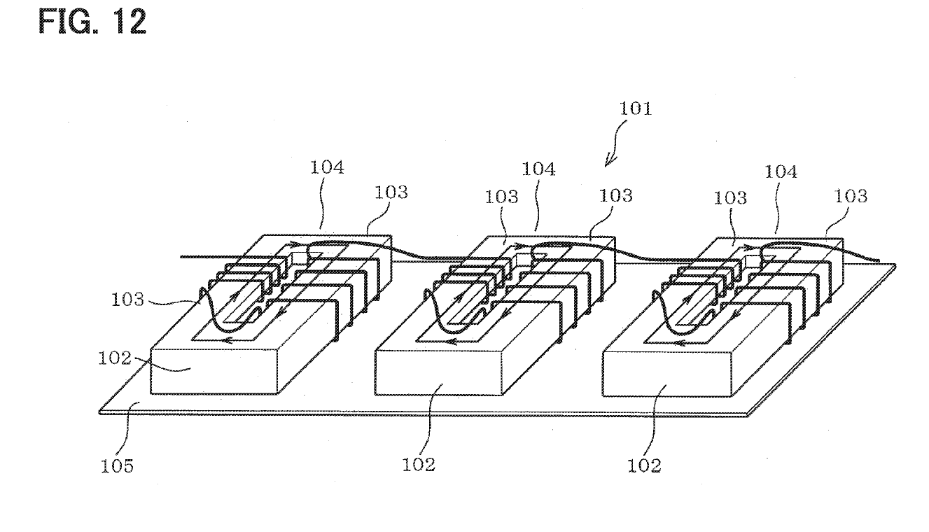

FIG. 10 shows a configuration of a reactor main body 81 according to an eighth embodiment of the present disclosure. Herein, a difference from the reactor main body 61 (see FIG. 8) of the sixth embodiment above will be described. The reactor main body 81 of the eighth embodiment includes one magnetic core 82 provided with two different reactors: a first reactor portion 81a in an upper row and a second reactor portion 81b in a lower row.

The magnetic core 82 includes an upper split core portion 83 and a lower split core portion 84, both of which are of a comb-teeth shape (E-shape) and provided as symmetrical upper and lower parts, and an intermediate yoke portion (beam portion) 85 shaped like a single horizontally-long rod (I-shape) and disposed at a midpoint between the two core portions 83 and 84 and used in common by the upper and lower reactor portions 81a and 81b. In the present embodiment, the intermediate yoke portion 85 is made of a material which is different from a material of the upper split core portion 83 and the lower split core portion 84 and has higher magnetic permeability than materials of other portions.

The first reactor portion 81a in the upper row is formed by wrapping respective four leg portions of the upper split core portion 83 with a first coil 86, a second coil 87, a third coil 88, and a fourth coil 89. As with the coils 14-17 of the first embodiment above, the coils 86-89 are suitably formed of flatwise coils and wound in a same number of turns in a same direction. The coils 86-89 are electrically connected in series. Consequently, when a DC current is passed between a pair of terminals, a current flows in the respective coils 86-89 in directions indicated by arrows C and three closed magnetic paths F1-F3 are formed.

As with the first reactor portion 81a, the second reactor portion 81b in the lower row is also formed by wrapping respective four leg portions of the lower split core portion 84 with a fifth coil 90, a sixth coil 91, a seventh coil 92, and an eighth coil 93. The coils 90-93 are electrically connected in series. When a DC current is passed between a pair of terminals of the coils 90-93, a current flows through the respective coils 90-93 in directions indicated by arrows C and three closed magnetic paths F4-F6 are formed.

In the present embodiment, magnetic fields of the closed magnetic paths F1-F6 in the intermediate yoke portion 85 are in directions such that the magnetic fields cancel out one another to restrict magnetic saturation in this portion. Moreover, because the intermediate yoke portion 85 is made of a material having high magnetic permeability, magnetic resistance in the intermediate yoke portion 85 can be reduced. Hence, a magnetic field generated in the reactor 81a gives less influence on the reactor 81b (a magnetic field generated in the reactor 81b gives less influence on the reactor 81a).

In a reactor of the eighth embodiment configured as above, too, radiation performance from a front surface or a rear surface of a case can be satisfactory while being relatively small (thin) in a front-back direction. At the same time, magnetic coupling between the reactor 81a and the reactor 81b can be loosened by restricting magnetic saturation in the magnetic core 82 in a portion corresponding to the intermediate yoke portion 85. Further, because two reactors, namely, the first reactor portion 81a and the second reactor portion 81b can be formed in one reactor main body 81, a size and the cost can be reduced. The magnetic core 82 may be replaced with the magnetic core 62 of the sixth embodiment above.

### Other Embodiments

Although it is not shown in the drawings, the present disclosure is not limited to the respective embodiments described above. For example, extensions and modifications as follows are also possible. That is, in the first embodiment or other embodiments above, coils are formed of flatwise coils. However, the coils are not limited to flatwise coils and the coils may be edgewise coils or normal round wires instead. Also, multiple coils are not necessarily connected in series and various types of connections can be combined. For example, a part of coils may be connected in series and the rest may be connected in parallel. The magnetic core may be provided with a gap. In a case where coils are embedded in the magnetic core, the coils may be shaped like a rectangular cylinder instead of a circular cylinder. In the first embodiment above, coils are wound around all of the four leg portions 13a-13d. However, in the present disclosure, as in the third embodiment above shown in FIG. 4, a flat reactor can be also formed by not winding coils around the leg portions 13a and 13d located at the ends.

In the respective embodiments above, the present disclosure is applied to a boost converter in a power control unit for a hybrid car. It should be appreciated, however, that the present disclosure is also applicable to various other usages, such as a PFC circuit in a charger, a non-isolated buck converter, and a smoothing choke. The present disclosure is disclosed under the title of “reactor” and it is needless to say that the term, “reactor”, includes an inductor. Materials of the respective portions, the numbers and the locations of the coils and the leg portions of the magnetic core, the numbers of turns in the coils, a cross-sectional area of the leg portions (minor diameters of the coils), and so on can be changed in various manners. Further, the leg portions may include leg portions which are left unwrapped by coils. In short, the present disclosure can be altered as needed within the scope of the present disclosure.

1. A reactor comprising:
a magnetic core; and
a plurality of coils disposed adjacent to each other and electrically connected to each other,
wherein the plurality of coils includes an intermediate coil inducing a magnetic flux which does not interlink with an end of the magnetic core, and magnetic paths forming at least two closed magnetic paths run through a portion inside the intermediate coil.

2. The reactor according to claim 1, wherein
the plurality of coils is formed in such a manner that electric currents flow in a same direction in adjacent portions of any two coils disposed adjacent to each other.

3. The reactor according to claim 1, wherein
the plurality of coils is electrically connected in series.

4. The reactor according to claim 1, wherein
the plurality of coils is disposed in such a manner that longer directions of any two coils disposed adjacent to each other do not intersect at a right angle.

5. The reactor according to claim 4, wherein
when radial directions and the longer directions of the plurality of coils are respectively set to a first direction and a second direction, the plurality of coils is disposed side by side in the first direction, or the plurality of coils is lined up in the second direction in a multiple sets and the multiple sets are disposed side by side in the first direction.

6. The reactor according to claim 5, wherein
the plurality of coils is lined up in the second direction in multiple sets and the multiple sets are disposed in the first direction in parallel, and
the plurality of coils is formed in such a manner that directions of magnetic fluxes induced by the coils in each of the sets lined up in the second direction are same.

7. The reactor according to claim 1, wherein
the plurality of coils is embedded in the magnetic core.

8. The reactor according to claim 1, wherein
each of the plurality of coils is the intermediate coil inducing a magnetic flux which does not interlink with the end of the magnetic core.

9. The reactor according to claim 1, wherein
the plurality of coils includes an end coil inducing a magnetic flux which interlinks with the end of the magnetic core, and
a cross-sectional area of the end coil is smaller than a cross-sectional area of the intermediate coil.

10. The reactor according to claim 1, wherein
the plurality of coils includes an end coil inducing a magnetic flux which interlinks with the end of the magnetic core,
the number of turns is same in all of the plurality of coils, and
a cross-sectional area of the end coil is half of a cross-sectional area of the intermediate coil.

11. The reactor according to claim 1, further comprising:
a reactor main body including the magnetic core provided with the plurality of coils; and
a radiator plate dissipating heat generated when the reactor main body is driven,
wherein a physical body of the reactor main body is flattened out in a planar direction of the radiator plate.

12. The reactor according to claim 11, wherein
the radiator plate is disposed on one surface side or both surface sides of the reactor main body.

13. The reactor according to claim 1, wherein
the plurality of coils is formed of flatwise coils.
